(19) United States
(12) Patent Application Publication
(10) Pub. No.: US 2014/0282277 A1
(43) Pub. Date: Sep. 18, 2014

(54) ADAPTIVE SEARCHING AND RANKING BASED ON GESTURES SIGNIFYING USER PREFERENCES

(71) Applicant: Sean Suhl, Los Angeles, CA (US)

(72) Inventor: Sean Suhl, Los Angeles, CA (US)

(21) Appl. No.: 13/897,092

(22) Filed: May 17, 2013

Related U.S. Application Data
(63) Continuation of application No. 13/842,073, filed on Mar. 15, 2013, now abandoned.

(51) Int. Cl. G06F 3/01

(52) U.S. Cl. CPC G06F 3/017
USPC 715/863

(57) ABSTRACT

A system and method for incrementally optimizing the selection or ranking of elements or items from a collection for a user, and providing for immediate modification of criteria used for selection of a next element of item based on simple user feedback on features or characteristics of a previously reviewed selection, as indicated by user gestures.

### CROSS-REFERENCE TO RELATED APPLICATIONS

This application is a continuation of co-pending U.S. patent application Ser. No. 13/842,073 entitled “ADAPTIVE SEARCHING AND RANKING BASED ON GESTURES SIGNIFYING USER PREFERENCES” (Attorney Docket No. 26588US01), filed Mar. 15, 2013, which is hereby incorporated herein by reference, in its entirety.

### FIELD OF THE INVENTION

Certain aspects of the invention relate to systems and methods that provide recommendations to those seeking help in identifying specific items from a collection of items. More specifically, certain aspects of the present invention relate to systems and methods for incrementally optimizing the selection or ranking of elements or items from a collection for a user, and provides for immediate modification of criteria used for selection of a next element of item based on simple user feedback on features or characteristics of a previously reviewed selection, as indicated by user gestures.

### BACKGROUND OF THE INVENTION

User selection of items from a collection is typically done using user defined search terms, which are used by a search engine to match against, for example, a filename or title of items in the collection, the text content of document items in the collection, or keywords assigned to each item in the collection. If in reviewing the results of a first search of the collection the user finds that the results were off-the-mark, the user then modifies their search terms and searches the collection again. This is usually repeated until the search results meet the needs of the user, or the user gives up. The user may not be aware of the keywords or characteristics for which searches may be performed, resulting in a less than effective trial-and-error search effort.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method that incrementally optimizes selection of items from a collection for a user using immediate modification of criteria used for a next selection based on simple user feedback on characteristics of a previously reviewed selection, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary system on which a representative embodiment of the present invention may be practiced.

FIG. 2 is a flowchart illustrating an exemplary method of operating a system for searching/ranking a collection of items for a user, in which positive and negative user responses to item characteristics is used to update the search/ranking algorithm resulting in an improved likelihood of a satisfactory outcome for the user, in accordance with a representative embodiment of the present invention.

FIG. 3 is an illustration of a portion of a touch-sensitive display showing a text message describing a particular feature or characteristic, upon which the user may employ a finger to perform an exemplary finger gesture to signify, for example, approval or disapproval, like or dislike, acceptance or rejection, or agreement or disagreement regarding the message conveyed by the underlying text, in accordance with one representative embodiment of the present invention.

FIG. 4 is an illustration of a portion of a touch-sensitive display showing a text message describing a particular feature or characteristic, in which a line having end points is displayed over the text message in response to a user gesture signifying negative user reaction regarding the underlying text, in accordance with one representative embodiment of the present invention.

FIG. 5 is an illustration of a portion of a touch-sensitive display showing a text message describing a particular feature or characteristic, in which an exemplary highlight having ends is displayed over the text message in response to a user gesture signifying a positive user reaction regarding the underlying text, in accordance with one representative embodiment of the present invention.

FIG. 6 is an illustration of an exemplary list of text messages describing features or characteristics of items or elements of a collection as it may appear, for example, on the display of a smart phone or personal computer, in which two text messages to which the user has expressed a negative reaction by use of a finger gesture have been “lined-out” or “stuck-out,” in accordance with a representative embodiment of the present invention.

FIG. 7 is an illustration of an exemplary list of text messages describing features or characteristics of items or elements of a collection as it may appear, for example, on the display of a smart phone or personal computer, in which two text messages to which the user has expressed a positive reaction by use of a finger gesture have been highlighted, in accordance with a representative embodiment of the present invention.

FIG. 8 is an illustration of an example touch sensitive display of a personal electronic device such as, for example, a smart phone, showing an exemplary profile of a member of a collection of people interested in finding compatible individuals, in accordance with one representative embodiment of the present invention.

FIG. 9 is an illustration of an example touch sensitive display of a personal electronic device such as, for example, a smart phone, showing an exemplary profile listing various personal characteristics of a member selected for the user of the personal electronic device from a collection of people interested in finding compatible individuals, in accordance with one representative embodiment of the present invention.

FIG. 10 is an illustration of an example touch sensitive display of a personal electronic device such as, for example, a smart phone, showing an exemplary group of personal characteristics of a member of a collection of people interested in finding compatible individuals identified during a search following incorporation of the negative user responses of discussed above with respect to FIG. 9, in accordance with one representative embodiment of the present invention.

FIG. 11 is an illustration of an example touch sensitive display of a personal electronic device such as, for example, a smart phone, showing an exemplary profile of a member of a collection of people interested in finding compatible individuals, in accordance with one representative embodiment of the present invention.

FIG. 12 is an illustration of an example touch sensitive display of a personal electronic device such as, for example, a smart phone, showing an exemplary profile listing various personal characteristics of a member selected for the user of the personal electronic device from a collection of people interested in finding compatible individuals, in accordance with one representative embodiment of the present invention.

FIG. 13 is an illustration of an example touch sensitive display of a personal electronic device such as, for example, a smart phone, showing an exemplary group of personal characteristics of a member of a collection of people interested in finding compatible individuals identified during a search following incorporation of the positive user responses as discussed above with respect to FIG. 12, in accordance with one representative embodiment of the present invention.

FIG. 14 is a block diagram illustrating a personal electronic device that may correspond, for example, to electronic devices shown in FIGS. 1 and 8-13, in accordance with a representative embodiment of the present invention.

### DETAILED DESCRIPTION OF THE INVENTION

Certain aspects of the invention relate to systems and methods that provide recommendations to those seeking help in identifying specific items from a collection of items. More specifically, certain aspects of the present invention relate to systems and methods for incrementally optimizing the selection or ranking of elements or items from a collection for a user, and provides for immediate modification of criteria used for selection of a next element of item based on simple user feedback on features or characteristics of a previously reviewed selection, as indicated by user gestures. The present invention incrementally improves the accuracy of the search results provided to a user by immediately adjusting the search or selection criteria based on the response of a user to user selected characteristics of a previous item selected for consideration by the user.

The following description of example systems and methods is not intended to limit the scope of the description to the precise form or forms detailed herein. Instead the following description is intended to be illustrative so that others may follow its teachings.

In accordance with a representative embodiment of the present invention, a system provides for the use of commodity hardware, off the shelf software, OS independent applications, form factor independent devices (e.g., PC, tablets, smart phones etc), media independent (e.g., voice, text, video) and cloud based infrastructure to run all functionalities of the present system.

The term “channel” in the present context may refer to various means of communicating such as, for example, online communication (e.g., Internet-based), mobile communication (e.g., wireless communication such as cellular or Wi-Fi), and in-store. The term “gesture” may be used herein to mean a motion of one or more fingers, hand, or other part of the body, made to express thought or feeling or to help express thought or feeling.

As utilized herein, the terms “exemplary” or “example” mean serving as a non-limiting example, instance, or illustration. As utilized herein, the term “e.g.” introduces a list of one or more non-limiting examples, instances, or illustrations.

The methods and systems disclosed herein may be part of any system created to efficiently aid a user in identifying or ranking items from a collection that are of greatest interest to the user. Such items may be, for example, product items available from a merchant that would satisfactorily meet the user's needs and expectations, books from library collections that the user would most likely enjoy, and individuals from a collection of people looking to identify others with whom they feel that they're most compatible and whom they would like to meet, to name just a few examples.

FIG. 1 is a block diagram of an exemplary system 100 on which a representative embodiment of the present invention may be practiced. As illustrated in FIG. 1, the system 100 includes an computing platform 150 comprising one or more web servers 154, one or more database servers 156, and one or more application servers 152. The elements of the computing platform 150 may be interconnected, and may singly or as a group be connected to Internet 105 via communication link 107, which may employ any suitable combination of wired or wireless data communication links. FIG. 1 also includes personal computers (PCs) 110, 115, which are connected to the Internet 105 by communications links 108, 109, respectively, which may be any suitable combination of wired or wireless data communication links. PCs 110, 115 may be any of, for example, a desktop computer, a laptop computer, a notebook computer, a netbook computer, a tablet computer, or any other electronic device having capabilities suitable for accessing the Internet 105 from, for example, a home, a small business, or any private or public area having suitable support for communications links 108, 109.

In addition, FIG. 1 illustrates a user communication device 125 that may comprise, for example, a tablet computer, smart phone, or other handheld electronic device capable of communicating with the computing platform 150 via a wireless network 120, a communication link 127, and the Internet 105. The communication device 125 of FIG. 1 may include suitable software applications, hardware, and logic to permit the communication device 125 to display received web pages and other forms of digital information on a display of the communication device 125, and suitable user interface (UI) elements to permit a user to interact with the computing platform 150 using tactual, speech, and other forms of input. The communication device 125 may be capable of having native applications installed on the communication device from repositories accessible as “app stores,” for example. The wireless network 120 may support communication of digital information using any suitable wireless access technology including, for example, any combination of short-range, long range, Wi-Fi, cellular, personal communication system (PCS), Bluetooth, Near Field communication (NFC), to name only a few possible air interface technologies.

FIG. 1 also includes a portable telephone that may be capable of communicating over one or more of a cellular, PCS, Wi-Fi, or other wireless communication network, and may have more limited yet sufficient functionality to interact with the e-commerce platform 150 than that available from the PCs 110, 115 and the communication device 125.

In addition, FIG. 1 illustrates a kiosk device 135, which may permit users in retail and public venues to access the computing platform 150. The kiosk device 135 may be designed for indoor or outdoor use, and may be linked to the computing platform 150 via a communication link 137 and Internet 105, as shown, or may communicate directly with the computing platform 150 using any other suitable wired or wireless means. The kiosk 135 may have functionality that is equivalent, greater than, or less than the personal computers 110, 115, the communications device 125, and the cellular telephone 130.

The illustration of FIG. 1 also shows a retail establishment 160 for a merchant that may, for example, be a “brick-and-mortar” business associated with the operator or sponsor of the computing platform 150. The computing platform 150 may support, for example, an electronic catalog of the products available through the retail establishment 160 or an on-line presence of the merchant. The retail establishment 160 may include a kiosk 164 that may support access to the computing platform 150 from the retail establishment 160, for those users that are located within the retail establishment 160. The illustration of FIG. 1 also includes a communication device 162 that may belong to, or be loaned to a customer of the merchant at the retail establishment 160, permitting the customer to, for example, electronically access information about products and/or services available at the retail establishment 160, at other business locations of the operator of the retail establishment 160, or via an Internet-based business of the merchant, or at other businesses operated by, for example, the operator, or businesses that partner with the operator of the computing platform 150. Communication devices within the retail business 160 such as, for example, the communication device 162 and the kiosk 164 may communicate with the computing platform 150 via the Internet 105 and the communication link 167, which may be, for example, any suitable combination of wired and/or wireless communication technologies.

In addition, the system 100 of FIG. 1 includes an application/web server 170 that may, for example, be operated by a third-party provider of applications selectable by users of the computing platform 150, and that may be arranged to interact with elements of the computing platform 150, as described more fully below.

In accordance with a representative embodiment of the present invention, the elements of a system such as the computing platform 150 of FIG. 1, for example, may include the functionality in a software application that enables users to search for information about people and/or things via the computing platform 150. The computing platform 150 may include software that enables social interaction of users, searching and/or ranking items or elements of collections such as, for example, information about products, people, publications, activities and events, hobbies, and interests with respect to criteria (e.g., features, characteristics, or behaviors) of interest to the user(s) of the computing platform 100. In addition, the software may support interfacing a variety of user communication devices including, for example, tablet, desktop, notebook, notepad, and network computers, cellular telephone and smart phones, public and private kiosks, and other suitable electronic user communication devices available at the present time or in the future.

In a representative embodiment of the present invention, a user may employ a personal electronic device such as, for example, a personal computer or smart phone to search, for example, for things, people, or information of interest to the user. The personal electronic device may include a touch-sensitive display, a touch pad, a mouse, or other suitable user input device that permits the user to employ one or more physical gestures of, for example, a finger, to indicate their feelings about and reactions to the displayed results of their searches for things, people, or information of interest.

In one representative embodiment of the present invention, the collection of items or elements may be, for example, an electronic catalog of items of an on-line or conventional brick-and-mortar merchant. In one example, a customer looking to find a particular product such as, for example, a dishwasher, meeting his/her needs may initially be asked to specify criteria, by identifying those features or characteristics they want in a dishwasher, or to indicate agreement or disagreement with a series of statements about dishwashers. This user input may be via a webpage of the on-line presence of the merchant, via a mobile application of a smart phone or, for example, at a kiosk within a retail location of the merchant.

In order to provide the customer with information about suitable products, and in this specific example, dishwashers in particular, the customer may be asked to identify some of the important features or characteristics of interest to them such as, for example, brand, available colors, style of racks, cycle time, noise level, water and power consumption, construction, repair history, warrantee coverage, and cost. In some representative embodiments of the present invention, the customer may be presented with a list of various features and characteristics of products, each with a number of possible choices for each feature or characteristic, and may be asked to select one or more of the available choices for those features or characteristics that are of importance to them. For example, the customer may select “stainless steel” for the “front panel color” feature, and may choose a “cost” of “between $450 and $600.” In other representative embodiments of the present invention, a system may present the customer with other ways to ascertain customer preferences such as, for example, a series of statements about products, (in this case, dishwashers in particular), to which they indicate agreement or disagreement, for example. In a representative embodiment of the present invention, a system such as, for example, the computing platform 150 of FIG. 1 may maintain a profile for each user. Such a profile may, for example, contain information representing such features, characteristics of things, and personal characteristics such as those described herein, and may be used as input to, and/or to modify or adjust, algorithms used to search for, or rank, elements of collections such as, for example, people, products, music, books, and movies.

It should be noted that, with regard to this illustrative example of a product (i.e., a dishwasher), the customer need not indicate choices for all of the features and characteristics of a product, and that their failure to select any of the choices for a given feature or characteristic or respond to any statement regarding aspects of a product may, for example, be taken as an indication of the lack of importance to the customer of that aspect of the product of interest. It should also be noted that the examples of ways of eliciting information about product features and characteristics of importance to the customer that have been described above do not necessarily represent specific limitations of the present invention, unless recited in the claims, and that other means may also be employed.

Once an initial gathering of information about the features and characteristics that the customer wants in a dishwasher is complete, a representative embodiment of the present invention may respond by identifying a first and best matching candidate dishwasher based on the criteria (e.g., product features and characteristics) selected by the customer. Identification of a suitable product to the user may be accompanied by, for example, a list identifying specific details regarding the features and characteristics of the product being presented to the user for consideration. Such a list may, for example, include specifics for many of the features and characteristics for which the customer gave detailed choices, but may also include information about features and characteristics for which the customer made no selection, or gave no indication of preference.

The customer may then review the displayed list of features and characteristics of the candidate product (i.e., a dishwasher), and may, in some cases, decide that certain features or characteristics listed for the candidate dishwasher are not acceptable. That is, they may decide that the product selected for them is not what they want, based on the presence of particular features or characteristics of the suggested product. It should be noted that the unacceptable features or characteristics may be some for which the customer provided choices, preferences, or indications of interest, and/or may also be features or characteristics in which the customer previously demonstrated no interest. In some representative embodiment of the present invention, the customer may express their lack of interest in, or dislike for, the candidate product by clicking on/selecting an icon or button labeled “No, Thanks” or “Not for me,” for example. In other representative embodiments of the present invention, the customer may specifically identify the features or characteristics that are the reasons for their dislike or lack of interest in the candidate product by, for example, “striking-out” or “lining through” a textual description of one or more undesirable product feature(s) using a fingertip gesture on a touch-sensitive display, or by clicking on/selecting a “thumbs down” icon associated with the feature or characteristics that the customer finds unacceptable.

In those cases in which the customer finds the selected product offering (i.e., a certain dishwasher) satisfactory, the customer may indicate such by, for example, clicking on/selecting an icon or button labeled “That's close,” or “I like it!,” for example. The customer may then specifically identify the features or characteristics that are particularly to their liking by, for example, highlighting a section of, or clicking on/selecting a “thumbs-up” icon associated with, the description of each of the desirable product feature(s).

If the customer is still not satisfied with the products they've been shown, they may then request to see information for any additional products that might meet his/her wants.

In a representative embodiment of the present invention, the algorithm used to identify the most suitable product from a collection of products may, for example, identify a group or set of one or more products to be presented to the customer, and may present to the user a certain number of those products whose level of match is satisfactory (e.g., exceeds a certain threshold of a measure of suitability). In a representative embodiment of the present invention, the next product to presented to the customer may be selected by immediately incorporating into the selection, the responses of the customer during review of the product just presented. That is, the expression by the customer of positive or negative feelings about an aspect of a product using, for example, a specific physical gesture on a touch-sensitive display may be immediately incorporated into the selection or ranking of additional products to be presented to the customer for consideration. In this way, a representative embodiment of the present invention enables immediate use of the customer identification of the undesirable and desirable features and characteristics of a product, in determining a more suitable product for the customer. In this manner, a search in accordance with a representative embodiment of the present invention continually adapts to incorporate in a subsequent search or ranking those aspects of a product that are customer-indentified as undesirable and desirable, to aid in avoiding the presentation of additional undesirable choices to the customer, and to increase the probability of providing desirable choices, which improves the efficiency of the customer search and the perception that the merchant has an understanding of what the customer actually seeks. It should be noted that the process of identifying elements from the collection (i.e., in this example, products from the electronic catalog of the merchant) may include identifying one or more items or elements from the collection based on features or characteristics previously provided, and responses to elements already presented to the user. This may involve, for example, replacing, modifying, and/or reordering a set of selections of elements previously delivered to the customer for review.

In another representative embodiment of the present invention, the collection may comprise individuals interested in meeting others with compatible interests for the purpose of, for example, friendships an/or dating. In such a representative embodiment, an individual looking to find someone that he/she may find attractive and compatible may be asked to self-identify with respect to a number of categories such as, for example, physical appearance, nationality, behaviors, vices, habits, feelings, beliefs, needs, tastes, and personal preferences. In some representative embodiments of the present invention, the individual may, for example, be asked to identify where they would place themselves on a numerical scale (e.g., 1-10) with regard to each of a number of categories, while in other representative embodiments of the present invention, the individual may be asked to choose from a number of statements, and/or to indicate a degree of agreement or disagreement with respect to one or more statements in regard to aspects of each category. This may be done, for example, via a webpage, or using a mobile application for a smart phone or portable computer.

After providing information about themselves, outlined above, the individual seeking to meet someone else may then be provided with information about others that have been determined to be compatible with them. A representative embodiment of the present invention may select one or more individuals found to be similar to the person seeking a friend/companion, at a certain level of compatibility, based on the self identification of each individual in the collection. The user may then be shown information for another that has been determined to be compatible with them, from the group of all such people seeking to meet someone.

In order to provide the user with information about other individuals with whom they may be a good match, the user seeking a compatible other may, as discussed above, initially be asked to identify some of the important features or characteristics that describe their own interests, such as those briefly discussed above. In some representative embodiments of the present invention, the user may be presented with a list of various personal characteristics such as, for example, their feelings about various things, their beliefs, their habits, their feelings on certain subjects, and their likes and dislikes. For each aspect of the user, a number of possible answers may be provided, and the user may be asked to select one or more of the available choices for those personal characteristics that are of importance to them. For example, the user may be presented with “Smoking” and be offered choices of “Never,” “Sometimes, when I'm stressed,” or “Two packs a day.” In other representative embodiments of the present invention, the user may be presented with other ways to ascertain their preferences such as, for example, a series of statements such as, “Smoking is disgusting,” to which they may respond with an indication of agreement or disagreement, for example.

It should be noted that user of this example need not provide responses or indicate choices for all of the characteristics, traits, behaviors, etc., present to them, and that their failure to select any of the possible choices or respond to any statement may, for example, be taken as an indication of the lack of importance to the user of that aspect of a person's life. It should also be noted that the examples of ways of eliciting information about individuals described above do not necessarily represent specific limitations of the present invention, unless recited in the claims, and that other means may also be employed.

Once the gathering of personal information about a user is complete, a representative embodiment of the present invention may respond by identifying one or more individuals that represent those individuals determined to be most compatible with the user, based upon the personal information submitted by the members of the collection or group of individuals seeking someone else. The identification to the user of one or more individuals may be accompanied by, for example, a list identifying information about their responses to various personal aspects of the indentified individual, which is presented to the user for consideration. Such a list may, for example, include specifics for many of the aspects (e.g., physical appearance, nationality, behaviors, habits, feelings, beliefs, needs, tastes, and personal preferences) for which the user gave detailed choices, but may also include information about features and characteristics for which the customer made no selection, or gave no indication of preference.

The recipient of the information may then review the details about the individuals identified as being possible matches for them and may, in some cases, decide that certain aspects of the listed individuals are not acceptable to them. For instance, they may decide that a habit or belief of an individual selected for them is not what they want in a friend/date. It should be noted that the unacceptable characteristics of a selected individual may be ones for which the customer provided preferences or indications of interest, and/or may also be characteristics in which the user previously expressed no interest or preference.

In some representative embodiments of the present invention, the user may express a lack of interest in, or dislike for, aspects of an individual by clicking on/selecting a button or icon labeled “No, Thanks” or “Not for me,” for example. The user may also be permitted to specifically identify those characteristics of the one selected for them that are the reasons for their dislike or lack of interest in the selected other by, for example, “striking-out” or “lining through” a textual description of one or more undesirable characteristic(s) using a fingertip gesture on a touch-sensitive display, or by clicking on/selecting a “thumbs down” button or icon associated with the personal characteristics that the user finds objectionable.

For those cases in which the user finds the selected individual attractive, the user may indicate that by, for example, clicking on/selecting an icon or button labeled “Let's Date” or “A definite possibility,” for example. The user may then specifically identify the personal characteristics that are particularly appealing by, for example, highlighting a section of, or clicking on/selecting a “thumbs-up” icon or button associated with, the description of each of the desirable aspects of the selected individual.

As has been described above, in a representative embodiment of the present invention, a user of a system that searches for or ranks elements of a collection may be presented with search results or rankings based on features or characteristics (e.g., in the case of the search for a satisfactory model of dishwasher from the inventory of a merchant) or the overall nature of an individual (e.g., the personal characteristics of members of a group of people looking for someone compatible for friendship or dating). The user may then provide feedback indicating their agreement or disagreement with various statements, or their likes and dislikes, or the attractiveness or dissatisfaction of various characteristics of an individual, to improve the likelihood or quality of a subsequent match or selection for additional people, from the collection.

In some representative embodiments of the present invention, a user wishing to show disagreement with a particular statement, dislike of a particular feature, or disapproval of a characteristic of a member of a collection may, for example, use the physical gesture of swiping a finger across the surface of the portion of a touch-sensitive display to, in effect, “strike out” or “line out” the undesirable, unacceptable, or unattractive aspect of, for example, a particular product, individual, food, book, city, to name only a few examples in which this tool may be used. In addition, some representative embodiments of the present invention may permit a user wishing to show approval, agreement, or attractiveness of a particular feature or characteristic of a member of a collection may

FIG. 2 is a flowchart illustrating an exemplary method of operating a system for searching/ranking a collection of items for a user, in which positive and negative user responses to item characteristics is used to update the search/ranking algorithm resulting in an improved likelihood of a satisfactory outcome for the user, in accordance with a representative embodiment of the present invention. The following description makes reference to the elements of FIG. 1. The method of FIG. 2 begins at block 210, where a system such as, for example, the computing platform 150 of FIG. 1 may receive, from the user, a set of characteristics of the members of the collection that are preferred by user. Next, the system may, at block 212, receive user input requesting selection of a member of the collection. The method of FIG. 2 may then, at block 214, select a member of the collection for the user, based on characteristics preferred by the user. Next, the system may, at block 216, show, to the user, characteristics of the system selected member of the collection. The system may then, at block 218, determine whether feedback from the user regarding the system selected member of collection was received. Next, at block 220, the system determines if positive feedback was received, if negative feedback was received, or if no feedback was received.

If it is determined at block 220 that positive feedback was received, the system may then, at block 222, receive user input identifying the characteristic(s) of the system selected member that caused a positive user response. The system may then, at block 224, modify the selection/ranking algorithm for this user to reflect the characteristic(s) of the system selected member that caused a positive response by this user. The method then loops back to block 212.

If, however, it is determined at block 220 that negative feedback was received, the system may, at block 226, receive user input identifying the characteristic(s) of the system selected member that caused a negative user response. The system may then, at block 230, modify the selection/ranking algorithm for this user to reflect the characteristic(s) of the system selected member that caused a negative response by this user. The method then loops back to block 212.

If, at block 222, it is determined that no feedback was received, the exemplary method of FIG. 2 simply returns to block 212.

FIG. 3 is an illustration of a portion of a touch-sensitive display 300 showing a text message 301 describing a particular feature or characteristic, upon which the user may employ a finger to perform an exemplary finger gesture to signify, for example, approval or disapproval, like or dislike, acceptance or rejection, or agreement or disagreement regarding the message conveyed by the underlying text, in accordance with one representative embodiment of the present invention. The illustration of FIG. 3 shows the hand 301 of a user with the tip of a finger in continuous contact with the surface of the touch-sensitive display 300 from an initial or starting point 303A moving across the surface to a final or ending point 303B in a substantially linear motion. In a representative embodiment of the present invention, the user of a device having a touch-sensitive screen may, for example, use the tip of a finger or other form of stylus, or a mouse, to make the gesture(s) described herein. In a representative embodiment of the present invention, the initial or starting point 303A and the final or ending point 303B may not be required to be at certain respective locations on the surface of the touch-sensitive display. Instead, the point of contact of the finger with the surface of the touch sensitive display may move across the area of the touch-sensitive display within which the text message (e.g., description of features or characteristics) is displayed, and may move in a direction that is substantially in alignment with the displayed text. In a representative embodiment of the present invention, such a manual gesture of the finger on a touch-sensitive surface may be interpreted as, for example, approval or disapproval, like or dislike, acceptance or rejection, agreement or disagreement, or interest or disinterest in regard to the information conveyed by the descriptive text in proximity to which the contact point of the finger is moving.

It should be noted that although FIG. 3 illustrates the motion of the point of contact as being in a left to right direction, the motion of the point of contact of the finger upon the touch sensitive surface of the display to convey this gesture may be in a different, substantially linear direction depending upon, for example, related cultural norms such as the normal direction for the reading of text (e.g., in some cultures, from right to left, top to bottom, etc.).

It should also be noted that a representative embodiment of the present invention may be practiced using, for example, the movement of a mouse cursor in response to movement of, for example, the hand 301, or the movement of a finger across a touch sensitive surface that is not integrated with a display screen. It should further be noted that user “strike-out” or “line-out” of text, as described herein, is not to be interpreted as a deletion of the underlying text from any document, but may instead be a gesture representing user input with respect to user feelings or reactions to the underlying text or graphical image.

In a representative embodiment of the present invention, the gesture described above may be accompanied by the display of a line across the displayed text message to represent “striking out” or “lining out” in cases where the user has a negative reaction to a feature or characteristic and wishes to indicate that he/she, for example, disagrees, disapproves, dislikes, or is dissatisfied with the characteristic or feature described by the displayed text message. In a representative embodiment of the present invention, the gesture described above may alternatively be accompanied by the display of a highlight of the displayed text message, in cases where the user has a positive reaction to a feature or characteristic and wishes to indicate that he/she, for example, agrees, approves, likes, or is satisfied with the characteristic or feature described by the displayed text message.

In some representative embodiments of the present invention, the line signifying the user “strike-out” or “line-out” may be drawn in a progressive fashion as the user moves the fingertip across the text block from left to right. During drawing of the line, one end of the line may progress across the text block or enclosing box, if present, and that end may not coincide with the point of contact of the fingertip with the touch sensitive screen, but may instead move along a straight path between a certain starting point near, for example, the upper-left-hand corner of a box enclosing the text block, or of an imaginary rectangular boundary enclosing the text block if an enclosing box is not present, to a certain ending point near, for example, the lower-right-hand corner of the box enclosing the text block of the imaginary rectangular boundary enclosing the text block if an enclosing box is not present. That is, in a representative embodiment of the present invention, the point of contact of a fingertip with a touch-sensitive screen, or the location of a cursor tracking movement of a mouse may not be a point at which pixels of the line signifying user “strike-out” or “line-out” is drawn.

FIG. 4 is an illustration of a portion of a touch-sensitive display 400 showing a text message 402 describing a particular feature or characteristic, in which a line 403 having end points 403A, 403B is displayed over the text message 402 in response to a user gesture signifying negative user reaction regarding the underlying text, in accordance with one representative embodiment of the present invention. The display of the line 403 may be in unison with the movement of, for example, the point of contact of a finger on a touch sensitive surface such as that of a touch sensitive display. The line 403 may, for example, be displayed across the text message 402 at an angle, or be displayed parallel to a line of text of the message 402, and may be drawn left to right, or right to left, as appropriate. In some representative embodiments of the present invention, the line may not have endpoint 403A, 403B that coincide with the initial and ending points of contact 303A, 303B of a finger on a touch sensitive surface, as in the illustration of FIG. 3, but may start and end at fixed locations with respect to the text message 402, or an enclosing text box, if present. In some representative embodiments of the present invention, the line may be drawn progressively, and may “self-complete” once the user has moved the point of contact across a certain fraction of the touch sensitive surface, or after the drawing of the line has progressed past, for example, a certain fraction of a maximum length for the text message 402. In addition, a representative embodiment of the present invention may permit a user to remove a line such as the line 403, if they decide that they do not, for example, disagree, disapprove, dislike, or are not dissatisfied with the characteristic or feature described by the displayed text message 402. This may be accomplished by, for example, the user making initial contact with the touch sensitive surface at the opposite end of the text message 402 such as, in proximity to the end point 403B, and moving the point of contact of the finger towards the end point 403A of the line 403.

FIG. 5 is an illustration of a portion of a touch-sensitive display 400 showing a text message 502 describing a particular feature or characteristic, in which an exemplary highlight 503 having ends 503A, 503B is displayed over the text message 502 in response to a user gesture signifying a positive user reaction regarding the underlying text, in accordance with one representative embodiment of the present invention. The display of the highlight 503 may be in unison with the movement of, for example, the point of contact of a finger on a touch sensitive surface such as that of a touch sensitive display. The highlight 503 may, for example, be displayed to cover a single line of the text message 502, or may be displayed to highlight the entire text message 502, and may be drawn left to right, or right to left, as appropriate. In some representative embodiments of the present invention, the highlight may not have endpoints 503A, 503B that coincide with the initial and ending points of contact 303A, 303B of a finger on a touch sensitive surface, as illustrated in FIG. 3, but may start and end at fixed locations with respect to the text message 402, or an enclosing text box, if present. In some representative embodiments of the present invention, the highlight may be drawn progressively, and may “self-complete” once the user has moved the point of contact across a certain fraction of a dimension of the touch sensitive surface, or after the drawing of the line has progressed past, for example, a certain fraction of a length for the text message 502. In addition, a representative embodiment of the present invention may permit a user to remove a highlight such as the highlight 503, if they decide that they do not, for example, agree, approve, like, or are not satisfied with the characteristic or feature described by the displayed text message 502. This may be accomplished by, for example, the user making initial contact with the touch sensitive surface at the opposite end of the text message 502 such as, in proximity to the end point 503B, and moving the point of contact of the finger towards the end point 503A of the highlight 503.

FIG. 6 is an illustration of an exemplary list 600 of text messages describing features or characteristics of items or elements of a collection as it may appear, for example, on the display of a smart phone or personal computer, in which two text messages 622, 624 to which the user has expressed a negative reaction by use of a finger gesture have been “lined-out” or “stuck-out,” in accordance with a representative embodiment of the present invention.

FIG. 7 is an illustration of an exemplary list 700 of text messages describing features or characteristics of items or elements of a collection as it may appear, for example, on the display of a smart phone or personal computer, in which two text messages 722, 724 to which the user has expressed a positive reaction by use of a finger gesture have been highlighted, in accordance with a representative embodiment of the present invention.

FIG. 8 is an illustration of an example touch sensitive display 801 of a personal electronic device 800 such as, for example, a smart phone, showing an exemplary profile of a member of a collection of people interested in finding compatible individuals, in accordance with one representative embodiment of the present invention. As shown in FIG. 8, the information shown in the touch sensitive display 801 includes a picture of an individual 805, a name 802 identifying the pictured individual, a number of personal characteristics 820 of the pictured individual, a “Let's Date” icon 810 identifying a portion of the touch sensitive display 801 through which the user may indicate a positive response to the pictured individual, and a “No, Thanks” icon 815 identifying a portion of the touch sensitive display 801 through which the user may indicate a negative response to the pictured individual.

FIG. 9 is an illustration of an example touch sensitive display 901 of a personal electronic device 900 such as, for example, a smart phone, showing an exemplary profile listing various personal characteristics of a member selected for the user of the personal electronic device 900 from a collection of people interested in finding compatible individuals, in accordance with one representative embodiment of the present invention. In the illustration of FIG. 9, a number of the personal characteristics 922, 924, 926, 928, 930 have been marked by the user to indicate a negative reaction using a finger gesture as discussed above. In a representative embodiment of the present invention, a user may be enabled to provide negative feedback on various features or characteristics of a member of a collection (e.g., a member of a group of people, a product, a book, a movie) using the finger gesture described above with respect to FIG. 3. The illustration of FIG. 9 also shows that a user may indicate when they have completed entry of any reaction(s) they may have to the displayed features or characteristics, using a “Press when done” icon 940. In a representative embodiment of the present invention, indicating completion of entry of positive or negative input regarding features or characteristics of a selected member of a collection may cause a profile for the user to be updated to reflect the information about the positive and negative responses, and/or the modification of a selection and/or ranking algorithm used to select a next member from the collection of interest to the user.

FIG. 10 is an illustration of an example touch sensitive display 1001 of a personal electronic device 1000 such as, for example, a smart phone, showing an exemplary group of personal characteristics 1020 of a member of a collection of people interested in finding compatible individuals identified during a search following incorporation of the negative user responses of discussed above with respect to FIG. 9, in accordance with one representative embodiment of the present invention. The group of personal characteristics 1020 may be, for example, the personal characteristics of an individual identified by a system (e.g., the computing platform 150) following incorporation of the reactions of the user to the personal characteristics of the prior member selected for the user from the collection such as, for example, as discussed above, into a user profile and/or search/ranking algorithms. Using this approach, a representative embodiment of the present invention may immediately incorporate user reactions, both positive and negative, into the profile and/or search algorithms used in selecting and/or ranking choice for the user of the personal electronic device 1000, in accordance with a representative embodiment of the present invention.

FIG. 11 is an illustration of an example touch sensitive display 1101 of a personal electronic device 1100 such as, for example, a smart phone, showing an exemplary profile of a member of a collection of people interested in finding compatible individuals, in accordance with one representative embodiment of the present invention. As illustrated in FIG. 11, the information shown in the touch sensitive display 1101 includes a picture of an individual 1105, a name 1102 identifying the pictured individual, a number of personal characteristics 1120 of the pictured individual, a “Let's Date” icon identifying a portion of the touch sensitive display 1101 through which the user may indicate a positive response to the pictured individual, and a “No, Thanks” icon identifying a portion of the touch sensitive display 1101 through which the user may indicate a negative response to the pictured individual.

FIG. 12 is an illustration of an example touch sensitive display 1201 of a personal electronic device 1200 such as, for example, a smart phone, showing an exemplary profile listing various personal characteristics of a member selected for the user of the personal electronic device 1200 from a collection of people interested in finding compatible individuals, in accordance with one representative embodiment of the present invention. In the illustration of FIG. 12, a number of the personal characteristics 1222, 1224, 1226, 1228, 1230, 1232 have been marked by the user to indicate a positive reaction using a finger gesture as discussed above. In a representative embodiment of the present invention, a user may be enabled to provide positive feedback on various features or characteristics of a member of a collection (e.g., a member of a group of people, a product, a book, a movie) using the finger gesture described above with respect to FIG. 5. The illustration of FIG. 12 also shows that a user may indicate when they have completed entry of any reaction(s) they may have to the displayed features or characteristics, using a “Press when done” icon. In a representative embodiment of the present invention, indicating completion of entry of positive or negative input regarding features or characteristics of a selected member of a collection may cause a profile for the user to be updated to reflect the information about the positive and negative responses, and/or the modification of a selection and/or ranking algorithm used to select a next member from the collection of interest to the user.

FIG. 13 is an illustration of an example touch sensitive display 1301 of a personal electronic device 1300 such as, for example, a smart phone, showing an exemplary group of personal characteristics 1320 of a member of a collection of people interested in finding compatible individuals identified during a search following incorporation of the positive user responses as discussed above with respect to FIG. 12, in accordance with one representative embodiment of the present invention. The group of personal characteristics 1320 may be, for example, the personal characteristics of an individual identified by a system (e.g., the computing platform 150) following incorporation of the reactions of the user to the personal characteristics of the prior member selected for the user from the collection such as, for example, as discussed above, into a user profile and/or search/ranking algorithms. Using this approach, a representative embodiment of the present invention may immediately incorporate user reactions, both positive and negative, into the profile and/or search algorithms used in selecting and/or ranking choice for the user of the personal electronic device 1300, in accordance with a representative embodiment of the present invention.

Finally, it should be noted that the accompanying illustrations are provided for illustrative purposes only, and do not necessarily represent specific limitations of the present invention, unless recited by the claims.

FIG. 14 is a block diagram illustrating a personal electronic device 1400 that may correspond, for example, to electronic devices shown in FIGS. 1 and 8-13, in accordance with a representative embodiment of the present invention. As shown in FIG. 14, the personal electronic device 1400 includes a processor 1410, an RF transceiver A 1402, an RF transceiver B 1403, a wired interface 1404, a display device 1420, a user input device 1430, an audio interface 1440, and a memory 1450. The processor 1410 may be, for example, a suitable microprocessor or microcomputer having sufficient computing power to control the personal electronic device 1400, and is operably coupled to the RF transceiver A 1402, the RF transceiver B 1403, and the wired interface 1404. The RF transceiver A 1402 and RF transceiver B 1403 may comprise any necessary circuitry, logic, and software/firmware for wireless communication over any of, for example, the cellular, Bluetooth, Wi-Fi (e.g., IEEE 802.11 a/b/g/n/ac), Zigbee, WiMAX, or any other wireless network known now or in the future. The wired interface 1404 may comprise any necessary circuitry, logic, and software/firmware for wired communication over any of, for example, an Ethernet, Universal Serial Bus, FireWire (IEEE 1394) or other wired networks known now or in the future.

The processor 1410 is also operably coupled to the memory 1450, and may be used for non-transitory storage of executable program instructions, parameters, and data for any of the circuitry of the personal electronic device 1400. The display device 1420 is also operably coupled to the processor 1410, and may comprise, for example, one or more LED, OLED, LCD, or other form of visual display capable of presenting text or graphics, and may comprise any circuitry, logic, or software/firmware to support, for example, a graphical user interface (GUI). The user input device 1430 may comprise, for example, suitable switches, buttons, or touch sensitive surfaces to enable user control and operation of the personal electronic device 1400, and may comprise any necessary circuitry, logic, and software/firmware to allow it to perform those functions. In a representative embodiment of the present invention, the user input device 1430 may be a touch sensitive surface at the viewing side of the display device 1420, enabling a user to use the touch sensitive surface of the display device to enter user inputs and respond to displayed information. The audio interface 1440 comprise any necessary circuitry, logic, and software to interface a microphone 1405 and a speaker 1406 to the processor 1410.

Aspects of the present invention may be found in a method of identifying an element of a collection. Such a method may comprise receiving particular values for an initial set of characteristics common to elements in the collection, from a user, and storing a representation of the particular values in a profile for the user. The method may also comprise identifying one or more elements from the collection whose characteristics match at least one of the particular values, based upon the profile, and presenting characteristics for each identified element to the user. The method may further comprise receiving input from the user representing one of a positive user reaction and a negative user reaction to the characteristics of each presented element, modifying the profile based upon the user input, and identifying, in direct response to the received input, at least one additional element from the collection based upon the modified profile.

In a representative embodiment of the present invention, the collection may comprise products of an electronic catalog, and may comprise individuals seeking compatible individuals. Identifying the one or more elements may comprise ranking two one or more elements according to a degree of match, and the user input representing one of a positive user reaction and a negative user reaction may comprise a user gesture. The user gesture may comprise a substantially linear movement of a finger in contact with a touch-sensitive surface, and the user gesture may comprise movement of a mouse resulting in substantially linear movement of a cursor over displayed text. Receiving input from the user representing a negative user reaction may comprise displaying a line over information describing a characteristic of the presented element, and receiving input from the user representing a positive user reaction may comprise displaying highlighted information describing a characteristic of the presented element.

Further aspects of the present invention may be observed in a system for performing a method of identifying an element of a collection, where the system comprises at least one processor for communicating with a user device, the at least one processor operable to, at least, perform the method described above.

Additional aspects of the present invention may be found in a non-transitory computer-readable medium having a plurality of code sections, each code section comprising a plurality of instructions executable by a processor for causing the processor to perform the method described above.

Although devices, methods, and systems according to the present invention may have been described in connection with a preferred embodiment, it is not intended to be limited to the specific form set forth herein, but on the contrary, it is intended to cover such alternative, modifications, and equivalents, as can be reasonably included within the scope of the invention as defined by this disclosure and appended diagrams.

Accordingly, the present invention may be realized in hardware, software, or a combination of hardware and software. The present invention may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A method of identifying an element of a collection, the method comprising:
in a computing system for communicative coupling to a plurality of user communication devices,
receiving particular values for an initial set of characteristics common to elements in the collection, from a user;
storing a representation of the particular values in a profile for the user;
identifying one or more elements from the collection whose characteristics match at least one of the particular values, based upon the profile;
presenting characteristics for each identified element to the user;
receiving input from the user representing one of a positive user reaction and a negative user reaction to the characteristics of each presented element;
modifying the profile based upon the user input; and
identifying, in direct response to the received input, at least one additional element from the collection based upon the modified profile.

2. The method of claim 1, wherein the collection comprises products of an electronic catalog.

3. The method of claim 1, wherein the collection comprises individuals seeking compatible individuals.

4. The method of claim 1, wherein identifying the one or more elements comprises ranking two or more elements according to a degree of match.

5. The method of claim 1, wherein the user input representing one of a positive user reaction and a negative user reaction comprises a user gesture.

6. The method of claim 5, wherein the user gesture comprises a substantially linear movement of a finger in contact with a touch-sensitive surface.

7. The method of claim 5, wherein the user gesture comprises movement of a mouse resulting in substantially linear movement of a cursor over displayed text.

8. The method of claim 1, wherein receiving input from the user representing a negative user reaction comprises displaying a line over information describing a characteristic of the presented element.

9. The method of claim 1, wherein receiving input from the user representing a positive user reaction comprises displaying highlighted information describing a characteristic of the presented element.

10. A system for performing a method of identifying an element of a collection, the system comprising:
at least one processor for communicating with a user device, the at least one processor operable to, at least:
receive particular values for an initial set of characteristics common to elements in the collection, from the user;
store a representation of the particular values in a profile for the user;
identify one or more elements from the collection whose characteristics match at least one of the particular values, based upon the profile;
present characteristics for each identified element to the user;
receive input from the user representing one of a positive user reaction and a negative user reaction to the characteristics of each presented element;
modify the profile based upon the user input; and
identify, in direct response to the received input, at least one additional element from the collection based upon the modified profile.

11. The system of claim 10, wherein the collection comprises products of an electronic catalog.

12. The system of claim 10, wherein the collection comprises individuals seeking compatible individuals.

13. The system of claim 10, wherein identifying the one or more elements comprises ranking two or more elements according to a degree of match.

14. The system of claim 1, wherein the user input representing one of a positive user reaction and a negative user reaction comprises a user gesture.

15. The system of claim 14, wherein the user gesture comprises a substantially linear movement of a finger in contact with a touch-sensitive surface.

16. The system of claim 14, wherein the user gesture comprises movement of a mouse resulting in substantially linear movement of a cursor over displayed text.

17. The system of claim 10, wherein receiving input from the user representing a negative user reaction comprises displaying a line over information describing a characteristic of the presented element.

18. The system of claim 10, wherein receiving input from the user representing a positive user reaction comprises displaying highlighted information describing a characteristic of the presented element.

19. A non-transitory computer-readable medium having a plurality of code sections, each code section comprising a plurality of instructions executable by a processor for causing the processor to:
receive particular values for an initial set of characteristics common to elements in the collection, from a user;
store a representation of the particular values in a profile for the user;
identify one or more elements from the collection whose characteristics match at least one of the particular values, based upon the profile;
present characteristics for each identified element to the user;
receive input from the user representing one of a positive user reaction and a negative user reaction to the characteristics of each presented element;
modify the profile based upon the user input; and
identify, in direct response to the received input, at least one additional element from the collection based upon the modified profile.

20. The non-transitory computer-readable medium of claim 19, wherein the collection comprises products of an electronic catalog.

21. The non-transitory computer-readable medium of claim 19, wherein the collection comprises individuals seeking compatible individuals.

22. The non-transitory computer-readable medium of claim 19, wherein identifying the one or more elements comprises ranking two or more elements according to a degree of match.

23. The non-transitory computer-readable medium of claim 19, wherein the user input representing one of a positive user reaction and a negative user reaction comprises a user gesture.

24. The non-transitory computer-readable medium of claim 23, wherein the user gesture comprises a substantially linear movement of a finger in contact with a touch-sensitive surface.

25. The non-transitory computer-readable medium of claim 23, wherein the user gesture comprises movement of a mouse resulting in substantially linear movement of a cursor over displayed text.

26. The non-transitory computer-readable medium of claim 19, wherein receiving input from the user representing a negative user reaction comprises displaying a line over information describing a characteristic of the presented element.

27. The non-transitory computer-readable medium of claim 19, wherein receiving input from the user representing a positive user reaction comprises displaying highlighted information describing a characteristic of the presented element.
